(19) United States
(12) Patent Application Publication
(10) Pub. No.: US 2009/0117811 A1
(43) Pub. Date: May 7, 2009

(54) MANUFACTURING METHOD OF ELECTRON-EMITTING DEVICE, MANUFACTURING METHOD OF ELECTRON SOURCE, AND MANUFACTURING METHOD OF IMAGE DISPLAY APPARATUS

(75) Inventors: Ryoji Fujiwara, Chigasaki-shi (JP); Michiyo Nishimura, Sagamihara-shi (JP); Yoji Teramoto, Ebina-shi (JP); Kazushi Nomura, Sagamihara-shi (JP); Shunsuke Murakami, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/262,674

(22) Filed: Oct. 31, 2008

(30) Foreign Application Priority Data
Nov. 7, 2007 (JP) 2007-289651

(51) Int. Cl. H01J 9/02

(52) U.S. Cl. 445/51

(57) ABSTRACT

A manufacturing method of an electron-emitting device according to a present invention including the steps of: preparing a substrate having a carbon film, and a terminating a surface of the carbon film with hydrogen by irradiating a light or particle beam locally to a part of the carbon film in an atmosphere including hydrocarbon or hydrogen or in an atmosphere including both hydrocarbon and hydrogen.

### BACKGROUND OF THE INVENTION

1. Field of the Invention

The present invention relates to a manufacturing method of an electron-emitting device, a manufacturing method of an electron source, and a manufacturing method of an image display apparatus.

2. Description of the Related Art

There is a field emission type (FE type) electron-emitting device and a surface conduction type electron-emitting device or the like in the electron-emitting device.

In FE type electron-emitting devices, a voltage is applied between a cathode electrode (and an electron-emitting film arranged above it) and a gate electrode, and electrons are extracted into vacuum from the cathode electrode (or electron-emitting film) by the voltage (electric field). For this reason, an operating electric field is greatly influenced by a work function and a shape of the cathode electrode (electron-emitting film) to be used. In general, it is necessary to select the cathode electrode (electron-emitting film) with small work function.

Japanese Patent Application Laid-open No. 9-199001 discloses an electron-emitting apparatus which has a metallic object as a cathode electrode and a semiconductor (diamond, AIN, BN or the like) jointed to the metallic object. Further, the above document discloses a method for terminating surface of a semiconductor film composed of diamond with film thickness of about 10 nm or less with hydrogen so as to make electron affinity of the semiconductor film negative. FIG. 6 shows a band diagram showing an electron emission principle of the electron-emitting device disclosed in Japanese Patent Application Laid-Open No. 9-199001. In the drawing, 1 denotes a cathode electrode, 141 denotes a semiconductor film, 3 denotes an extraction electrode (gate electrode or anode electrode), 4 denotes a vacuum barrier, and 6 denotes an electron.

The diamond (semiconductor film) whose surface is terminated with hydrogen is a typical material, which has negative electron affinity. An electron-emitting device where surface of the diamond having negative electron affinity is used as an electron-emitting surface is disclosed in U.S. Pat. Nos. 5,283,501, 5,180,951, and “Environmental effect on the electron emission from diamond surfaces” written by V. V. Zhinov, J. Liu et al., J. Vac. Sci. Technol., B16(3), May/June, 1998, pp. 1188-1193.

In the electron-emitting device using diamond, electrons can be emitted from a low threshold electric field (electric field which is minimally required for emitting electrons) and high emission current can be generated.

However, in the case where a semiconductor having negative electron affinity or a semiconductor having very small positive electron affinity is used for electron-emitting device, if once electrons are injected into the semiconductor, the electrons are approximately always emitted. For this reason, in the case that such electron-emitting device is applied to display or electron source, it is occasionally very difficult to control an electron emission amount (particularly switching between on and off).

Therefore, the inventors of the present invention propose an electron-emitting device described in Japanese Patent Application Laid-Open No. 2005-26209 as an electron-emitting device which provides sufficient on/off property and can perform a high-efficient emission of electron with a low voltage. Further, the inventors propose an electron source having the electron-emitting device and an image display apparatus which provides high-contrast in Japanese Patent Application Laid-Open No. 2005-26209.

### SUMMARY OF THE INVENTION

A manufacturing method of an electron-emitting device described in Japanese Patent Application Laid-Open No. 2005-26209 includes a step of forming a dipole layer on the surface of the insulating layer by chemically modifying a surface of an insulating layer. The chemical modification is carried out by thermally treating a whole portion in a hydrocarbon gas. A temperature necessary for effectively terminating surface of the insulating layer with hydrogen is 600° C. or more.

On the other hand, in the case of that the electron-emitting device are used to display panel, various glasses are generally used as substrates (base) for forming the electron-emitting device. A flexibility point of the glass generally used as the substrates is lower than a flexibility point of quartz and silicon substrates. Concretely, the flexibility point is 550° C. or less.

That is to say, in the case of that the electron-emitting device described in Japanese Patent Application Laid-Open No. 2005-26209 is formed as a display panel on a glass substrate, the surface cannot be sufficiently chemically modified, and thus the property of the electron-emitting device cannot be improved. Further, since a high-temperature process at 600° C. is inserted during the steps, the cost increases.

It is, therefore, an object of the present invention to provide a manufacturing method of an electron-emitting device which has sufficient electron emission characteristic and is simple, a manufacturing method of an electron source and a manufacturing method of an image display apparatus.

A manufacturing method of an electron-emitting device according to the present invention including the steps of: preparing a substrate having a carbon film; and terminating a surface of the carbon film with hydrogen by irradiating a light or particle beam locally to a part of the carbon film in an atmosphere including hydrocarbon or hydrogen or in an atmosphere including both hydrocarbon and hydrogen.

In a manufacturing method of an electron source having a plurality of electron-emitting devices according to the present invention, each of the plurality of electron-emitting devices is manufactured by the manufacturing method of electron-emitting device according to the present invention.

In a manufacturing method of an image display apparatus having an electron source and a light emitting member for emitting light due to irradiation of electrons, the electron source is manufactured by the manufacturing method of an electron source according to the present invention.

According to the present invention, the manufacturing method of the electron-emitting device which has sufficient electron emission characteristic and is simple, the manufacturing method of the electron source and the manufacturing method of the image display apparatus can be provided.

Further features of the present invention will become apparent from the following description of exemplary embodiments with reference to the attached drawings.

### BRIEF DESCRIPTION OF THE DRAWINGS

FIGS. 1A to 1C are views showing a manufacturing method of an electron-emitting device according to an embodiment of the present invention;

FIG. 2 is a view showing voltage-current characteristic of the electron-emitting device according to Example 1 and a comparative example;

FIG. 3A is a band diagram in the case of that a driving voltage is 0 [V] in an electron-emitting device described in Japanese Patent Application Laid-Open No. 2005-26209, and FIG. 3B is a band diagram in the case of that a driving voltage V [V] is applied to the electron-emitting device described in Japanese Patent Application Laid-Open No. 2005-26209;

FIG. 4 is a partially enlarged schematic view showing the electron-emitting device described in Japanese Patent Application Laid-Open No. 2005-26209;

FIGS. 5A to 5E are views showing one example of a manufacturing method of the electron-emitting device described in Japanese Patent Application Laid-Open No. 2005-26209;

FIG. 6 is a band diagram showing an electron emission principle of the electron-emitting device disclosed in Japanese Patent Application Laid-Open No. 9-199001;

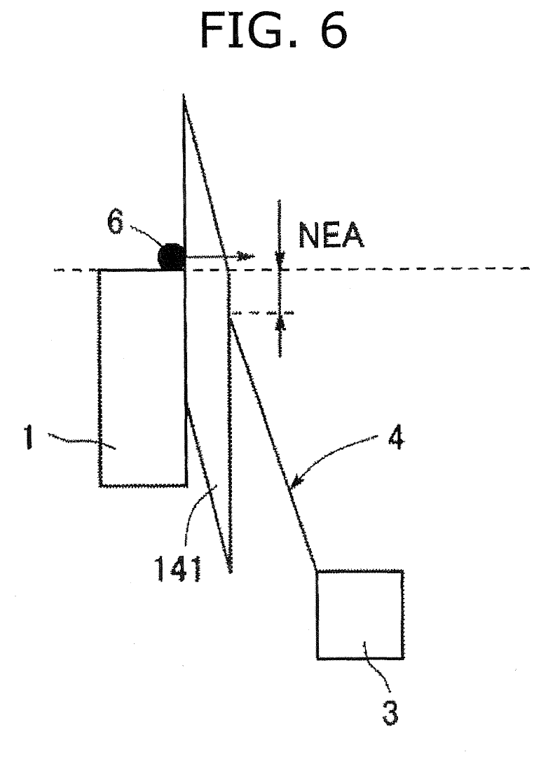

FIG. 7 is a schematic view showing a constitution of an electron source; and

FIG. 8 is a schematic view showing a constitution of an image display apparatus.

### DESCRIPTION OF THE EMBODIMENTS

A preferable embodiment of the present invention is described as an example in detail below with reference to the drawings. The scope of the present invention is not limited only to sizes, materials, shapes and relative arrangements of components described in the embodiment unless otherwise noted.

An electron-emitting device according to the embodiment of the present invention has a carbon film. A manufacturing method of the electron-emitting device includes a step of forming a dipole layer on a carbon film. The dipole layer is formed (a carbon film whose surface is terminated with hydrogen is formed) by locally irradiating a light or a particle beam to a part of the carbon film in an atmosphere including hydrocarbon or hydrogen or in an atmosphere including both hydrocarbon and hydrogen. For this reason, the terminating process can be executed without thermally damaging a substrate (even a thermally fragile substrate such as glass).

One example of the electron-emitting device according to the embodiment of the present invention is described below. A constitution of the electron-emitting device according to the embodiment of the present invention is not limited to the following constitution, and the device may have any constitution as long as it has a carbon film as an electron-emitting member.

In the electron-emitting device according to the embodiment, electrons are extracted from the electron-emitting member into vacuum by using a quantum-mechanical tunneling of carriers in an insulating layer and a tunneling in vacuum barrier which is reduced by terminating the electron-emitting member with hydrogen.

The electron-emitting device according to the embodiment has a cathode electrode, an insulating layer which covers at least a part of a surface of the cathode electrode and has a dipole layer on its surface, and an extraction electrode. By that a voltage is applied between the cathode electrode and the extraction electrode, electrons are tunneled from the cathode electrode through the insulating layer and a vacuum barrier and the electrons are emitted into vacuum in a state that the vacuum barrier which contacts with the dipole layer is higher than a conduction band in the surface of the insulating layer.

In the electron-emitting device according to the embodiment, the dipole layer is formed by terminating the surface of the insulating layer with hydrogen, and the insulating layer contains carbon as a main component. In the electron-emitting device according to the embodiment, a thickness of the insulating layer is preferably 10 nm or less. At the time of emitting electrons, the surface of the insulating layer preferably has positive electron affinity. Surface roughness of the insulating layer is preferably smaller than 1/10 of the film thickness of the insulating layer in RMS.

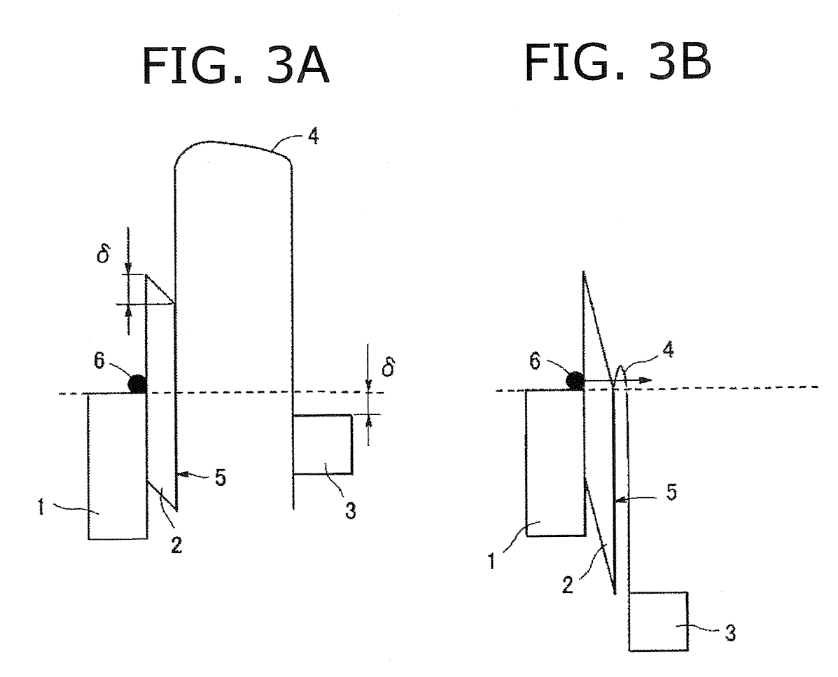

An electron emission principle in the electron-emitting device according to the embodiment is described below with reference to FIGS. 3A and 3B. In the drawing, 1 denotes a cathode electrode, 2 denotes an insulating layer, 3 denotes an extraction electrode, 4 denotes a vacuum barrier, 5 denotes an interface between the insulating layer 2 on which the dipole layer is formed on its surface and the vacuum, and 6 denotes an electron.

The electron 6 is extracted from the insulating layer 2 into the vacuum by applying a higher potential than an electric potential of the cathode electrode 1 to the extraction electrode 3. A voltage between the cathode electrode 1 and the extraction electrode 3 is a driving voltage.

FIG. 3A is a band diagram in the case of that the driving voltage is 0 [V] in the electron-emitting device according to the embodiment, and FIG. 3B is a band diagram in the case of that the driving voltage V [V] is applied to the electron-emitting device according to the embodiment.

In FIG. 3A, the insulating layer 2 is polarized by the dipole layer formed on the surface of the insulating layer 2, thus a voltage of δ is applied. If the voltage V [V] is applied to this state, the band of the insulating layer 2 is bent more steeply, and simultaneously the vacuum barrier 4 is also bent more steeply. In this state, the vacuum barrier 4 which contacts with the dipole layer is higher than a conduction band on the surface of the insulating layer 2 (see FIG. 3B). And, in this state, the electron 6 injected from the cathode electrode 1 tunnels the insulating layer 2 and the vacuum barrier 4 and then the electron 6 is emitted into the vacuum. The driving voltage in the electron-emitting device described in Japanese Patent Application Laid-Open No. 2005-26209 is preferably 50 [V] or less, and more preferably, not less than 5 [V] and not more than 50 [V].

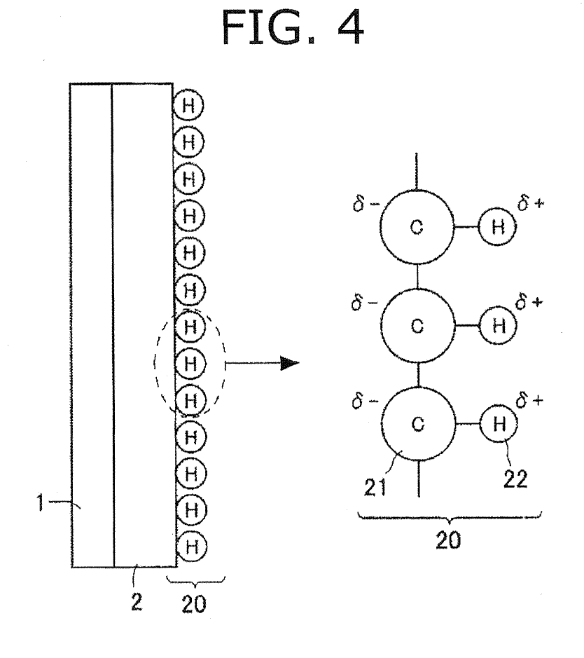

The state of FIG. 3A is described with reference to FIG. 4. In the drawing, 20 denotes a dipole layer, 21 denotes a carbon atom, and 22 denotes a hydrogen atom. The material by which the surface of the insulating layer 2 is terminated preferably may reduce a surface level of the insulating layer 2 in a state that a voltage is not applied between the cathode electrode 1 and the extraction electrode 3, but preferably hydrogen is used. Further, the material by which the surface of the insulating layer 2 is terminated preferably reduces the surface level of the insulating layer 2 by 0.5 eV or more, preferably 1 eV or more in the state that the voltage is not applied between the cathode electrode 1 and the extraction electrode 3. In the electron-emitting device according to the embodiment, when the driving voltage is applied between the cathode electrode 1 and the extraction electrode 3 and when the driving voltage is not applied therebetween, the surface level of the insulating layer 2 should show positive electron affinity. The voltage to be applied to the anode electrode is generally about dozen kV to 30 kV. For this reason, intensity of an electric field formed between the anode electrode and the electron-emitting device is generally considered to be about 1×10⁵ V·cm or less. Therefore, it is preferable that the electron is prevented from being emitted from the electron-emitting device by the electric field intensity. For this reason, the electron affinity of the surface of the insulating layer 2 on which the dipole layer is formed is preferably set to 2.5 eV or more with consideration of the film thickness of the insulating layer, mentioned later.

The film thickness of the insulating layer 2 can be determined by the driving voltage, but it is preferably set to 20 nm or less, more preferably to 10 nm or less. A lower limit, of the film thickness of the insulating layer 2 may be such that when the electron-emitting device is driven, a barrier (the insulating layer 2 and a vacuum barrier) through which the electron 6 supplied from the cathode electrode 1 is tunneled is formed. The lower limit is preferably set to 1 nm or more from a viewpoint of formation reproducibility.

In the electron-emitting device according to the embodiment, the insulating layer 2 always shows positive electron affinity so that a clear on-off ratio of the electron-emitting amount between selection and non-selection which is a conventional problem is secured.

The dipole layer 20 shown in FIG. 4 is an example where the surface of the insulating layer 2 is terminated with the hydrogen atoms 22. In general, the hydrogen atoms 22 are slightly polarized into positive (δ+). As a result, the atoms on the surface of the insulating layer 2 (in this case, carbon atoms 21) are slightly polarized into negative (δ−), so that the dipole layer 20 (in other words, “electric double layer”) is formed.

Therefore, as shown in FIG. 3A, in the electron-emitting device according to the embodiment, even if the driving voltage is not applied between the cathode electrode 1 and the extraction electrode 3, a state which is equivalent to that when an electric potential δ [V] of the electric double layer is applied to the surface of the insulating layer is formed. As shown in FIG. 3B, a drop of the surface level of the insulating layer 2 progresses due to the application of the driving voltage V [V], and in conjunction with this, the vacuum barrier 4 is also lowered. In the electron-emitting device according to the embodiment, the film thickness of the insulating layer 2 is suitably set to a film thickness such that the electron can be tunneled through the insulating layer 2 by the driving voltage V [V], but is preferably set to 10 nm or less with consideration of a load on a driving circuit or the like. If the film thickness becomes about 10 nm, a spacial distance with which the electron 6 supplied from the cathode electrode 1 passes through the insulating layer 2 can be shortened by applying the driving voltage V [V]. As a result, the electron 6 can be tunneled through the insulating layer 2.

As mentioned above, the vacuum barrier 4 is also lowered in conjunction with the application of the driving voltage V [V], and its spatial distance is also shortened similarly to the insulating layer 2. For this reason, the vacuum barrier 4 is brought into a tunnel enabled state, so that the electron emission into vacuum is realized.

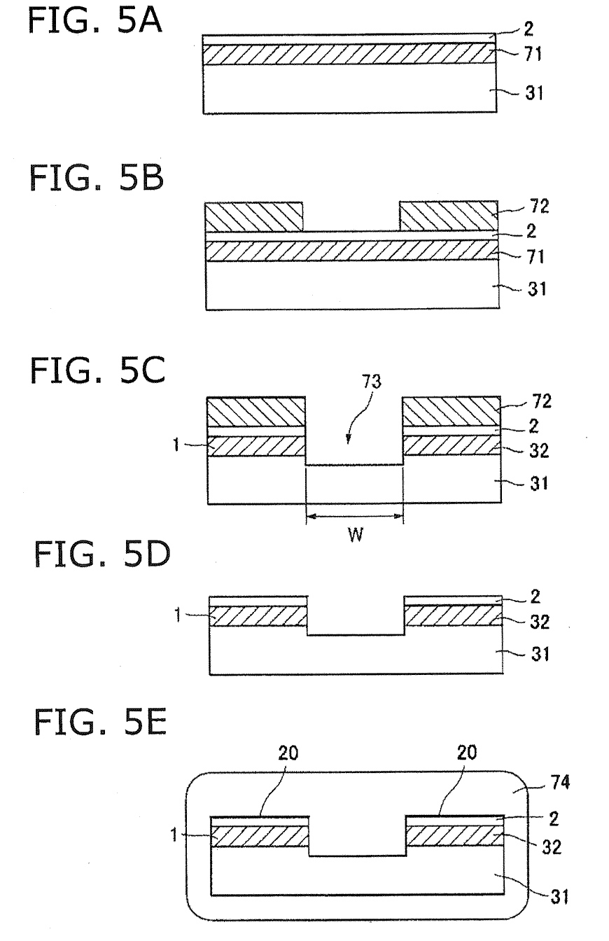

One example of the manufacturing method of the electron-emitting device according to the embodiment is described below with reference to FIGS. 5A to 5E.

### (Step 1)

An electrode layer 71 is laminated on a substrate 31 whose surface is sufficiently cleaned. As the substrate 31, any one of quarts glass, glass whose impurity (Na or the like) containing amount is reduced, soda lime glass, a laminated body obtained by laminating SiO₂ on surface of a substrate, an insulating substrate made of ceramics or the like is used.

The electrode layer 71 is generally has conductive property, and is formed by a general vacuum deposition technique such as a vacuum evaporation method and a sputtering method. The material of the electrode layer 71 is suitably selected from, for example, metal such as Be, Mg, Ti, Zr, Hf, V, Nb, Ta, Mo, W, Al, Cu, Ni, Cr, Au, Pt or Pd, or a alloy material. The thickness of the electrode layer 71 is set within a range of several dozen nm to several hundreds μm, and preferably, a range of 100 nm to 10 μm.

### (Step 2)

As shown in FIG. 5A, the insulating layer 2 is formed on the electrode layer 71. The insulating layer 2 is formed by a general deposition technique such as the vacuum evaporation method, the sputtering method, an HFCVD (Hot Filament CVD) method and a plasma CVD method. The method is, however, not limited. The film thickness of the insulating layer 2 is set within a range of a film thickness such that the electron can tunnel, and preferably within a range of a several run to 10 nm.

The material of the insulating layer 2 contains carbon as a main component (carbon film), and the material having smaller dielectric constant is preferable with consideration of concentration of an electric field. The material preferably has resistivity of 1×10⁸ to 1×10¹⁴ Ωcm. Concretely, as the insulating layer 2, diamond-like carbon (DLC), amorphous carbon, metal carbide can be used. Particularly, its main component is preferably SP³ carbon.

### (Step 3)

In order to separate the electrode layer 71 into the cathode electrode 1 and the gate electrode 32, a photoresist 72 is patterned (FIG. 5B).

### (Step 4)

An etching process is executed, thereby, as shown in FIG. 5C, the electrode layer 71 is separated into two electrodes (the gate electrode 32 and the cathode electrode 1). At the etching step for the electrode layer 71 and the insulating layer 2, an etching surface is desirably formed into a smooth and vertical shape or a smooth and tapered shape, and an etching method is selected according to materials. Dry etching or wet etching may be adopted. Normally, a width W of an opening portion (concave portion) 73 is suitably set according to a material composing the device and its resistance, a work function and a driving voltage of the material of the electron-emitting device, and a necessary shape of an electron emission beam. A gap W between the gate electrode 32 and the cathode electrode 1 is preferably set to several hundreds nm to 100 μm.

The surface of the substrate 31 exposed between the cathode electrode 1 and the gate electrode 32 is preferably engraved as shown in FIG. 5C. The surface of the substrate 31 between the cathode electrode 1 and the gate electrode 32 is made into a concave shape (concave portion), so that a creepage distance between the cathode electrode 1 and the gate electrode 32 can be effectively lengthened at the time when the electron-emitting device is driven. As a result, a leak current between the cathode electrode 1 and the gate electrode 32 can be reduced.

### (Step 5)

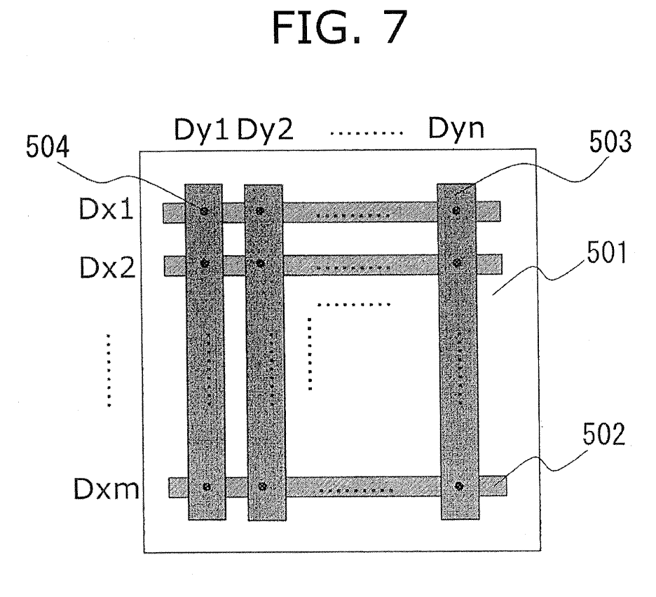

As shown in FIG. 7D, the photoresist 72 is removed.

### (Step 6)

Finally, the surface of the insulating layer 2 is terminated with hydrogen by carrying out a heat treatment (terminating process; chemical modification). As a result, the dipole layer 20 is formed on the insulating layer surface. 7 4 in FIG. 5E shows its atmosphere. In the manufacturing method of the electron-emitting device according to the embodiment, the atmosphere may contain any one of hydrocarbon such as CH₄ or C₂H₆ or hydrogen. A pressure of the atmosphere is preferably 2×10² Pa or more to 7×10³ Pa or less.

In the electron-emitting device according to the embodiment, the insulating layer surface is terminated with hydrogen by carrying out the heat treatment in a hydrocarbon gas. Concretely, the chemical modification is made by locally irradiating a light beam or a particle beam to a part of the carbon film in an atmosphere including hydrocarbon or hydrogen or in an atmosphere including both hydrocarbon and hydrogen. As a result, the chemical modification (terminating process) can be sufficiently made without thermally damaging the substrate. As the light to be locally irradiated, a laser light or the like is suitably selected.

In above description, an example is shown that the dipole layer 20 is formed on surface of the insulating layer on both the cathode electrode 1 and the gate electrode 32. However, in this embodiment, since a part can be locally heated, the dipole layer 20 can be formed only on the insulating layer on the side of the cathode electrode 1.

### <<Practical Application>>

An example where the electron-emitting device according to the embodiment of the present invention is applied to an electron source and an image display apparatus is described below.

### (Electron Source)

Various types of arrangements of the electron-emitting device are adopted. As one example, a plurality of electron-emitting devices are arranged in X and Y directions in a matrix. One sides of the electrodes of the plural electron-emitting devices arranged in the same row are connected commonly to a wiring in the X direction, and the other sides of the electrodes of the plural electron-emitting devices arranged in the same column are connected commonly to a wiring in the Y direction. This is called simple matrix arrangement.

The electron source of the simple matrix arrangement obtained by arranging the plurality of the electron-emitting devices is described below with reference to FIG. 7. As shown in FIG. 7, the electron source has an electron source substrate 501, X-direction wirings 502, Y-direction wirings 503 and electron-emitting devices 504.

The X-direction wirings 502 are composed of m-numbered wirings Dx1, Dx2, . . . Dxm, and can be composed of conductive metal formed by using the vacuum evaporation method, a printing method or the sputtering method. A material, a film thickness and a width of the wirings are suitably designed. The Y-direction wirings 503 are composed of n-numbered wirings Dy1, Dy2, . . . Dyn, and are formed similarly to the X-direction wirings 502. An inter-layer insulating layer, not shown, is provided between the m-numbered X-direction wirings 502 and the n-numbered Y-direction wirings 503 so as to electrically separate them (m and n are positive integers).

The inter-layer insulating layer, not shown, is made of SiO₂ or the like formed by the vacuum evaporation method, the printing method or the sputtering method. For example, the inter-layer insulating layer is formed into a desired shape on a whole or partial surface of the electron source substrate 501 where the X-direction wirings 502 are formed. The film thickness, the material and the manufacturing method are suitably set so as to withstand a potential difference on cross sections between the X-direction wirings 502 and the Y-direction wirings 503. The X-direction wirings 502 and the Y-direction wirings 503 are extracted as external terminals.

The electron-emitting device 504 has a pair of electrodes (gate electrode and a cathode electrode). In the example of FIG. 7, the gate electrode is electrically connected to any one of the n-numbered Y-direction wirings 503 by a wire connection made of conductive metal or the like. The cathode electrode is electrically connected to any one of the m-numbered X-direction wirings 502 by a wire connection made of conductive metal or the like.

A material composing the X-direction wirings 502 and the y-direction wirings 503, a material composing the wire connections and a material composing the pair of device electrodes may be partially or wholly uniform in constituent element or different from one another. For example, these materials are suitably selected according to the material of the device electrode. If the material composing the device electrode and the material of the wiring are the same, the wiring connected to the device electrode can be the device electrode.

The X-direction wirings 502 are connected to a scanning signal applying unit, not shown. The scanning signal applying unit applies a scanning signal to the electron-emitting device 504 connected to the selected X-direction wirings. On the other hand, the Y-direction wirings 503 are connected to a modulation signal generating unit, not shown. The modulation signal generating unit applies a modulation signal modulated according to an input signal to the respective columns of the electron-emitting devices 504. The driving voltage to be applied to each electron-emitting device is supplied as a difference voltage between the scanning signal and the modulation signal applied to the device.

### (Image Display Apparatus)

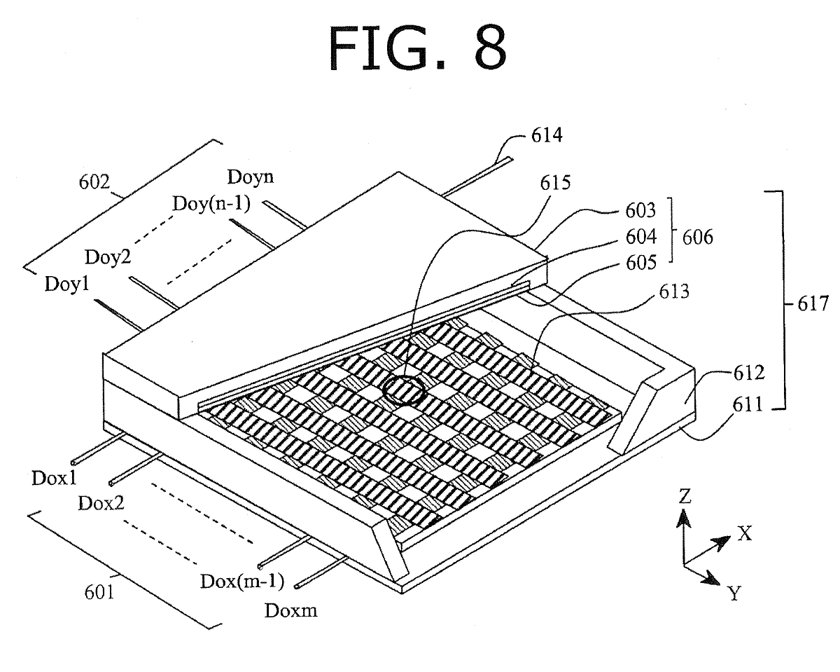

In the above constitution, individual device is selected by using the simple matrix wiring so as to be capable of being individually driven. The image display apparatus constituted by using the element source is described with reference to FIG. 8. FIG. 8 is a schematic view showing one example of a display panel of the image display apparatus.

As shown in FIG. 8, the image display apparatus has a container external terminal 601 in a X direction, a container external terminal 602 in a Y direction, an electron source substrate 613, a rear plate 611, a face plate 606, and a supporting frame 612. The electron source substrate 613 has a plurality of electron-emitting devices 615, and the rear plate 611 fixes the electron source substrate 613. The face plate 60 6 is formed with a phosphor film 604 as a phosphor which is an image forming member (a light emitting member which emits light due to emission of electrons), and a metal back 605 on an inner surface of a glass substrate 603. The rear plate 611 and the face plate 606 are connected to the supporting frame 612 by using frit glass or the like. An external container 617 is sealed by firing for 10 minutes or more in the atmosphere or nitrogen within a temperature range of 400 to 500° C.

The image display apparatus applies a voltage to each electron-emitting device 615 via container external terminals Dox1 to Doxm and Doy1 to Doyn. Each electron-emitting device 615 emits electrons according to the applied voltage.

A high voltage is applied to the metal back 605 or a transparent electrode (not shown) via a high-voltage terminal 614, so that the emitted electrons are accelerated.

The accelerated electrons collide with the phosphor film 604, and light is emitted so that an image is formed.

The image display apparatus according to this embodiment can be used as a display apparatus for television broadcasting, a display apparatus of video conference system or a computer, or an image display apparatus as an optical printer constituted by using a photosensitive drum.

### EXAMPLE

Examples of the present invention are described in detail below.

### Example 1

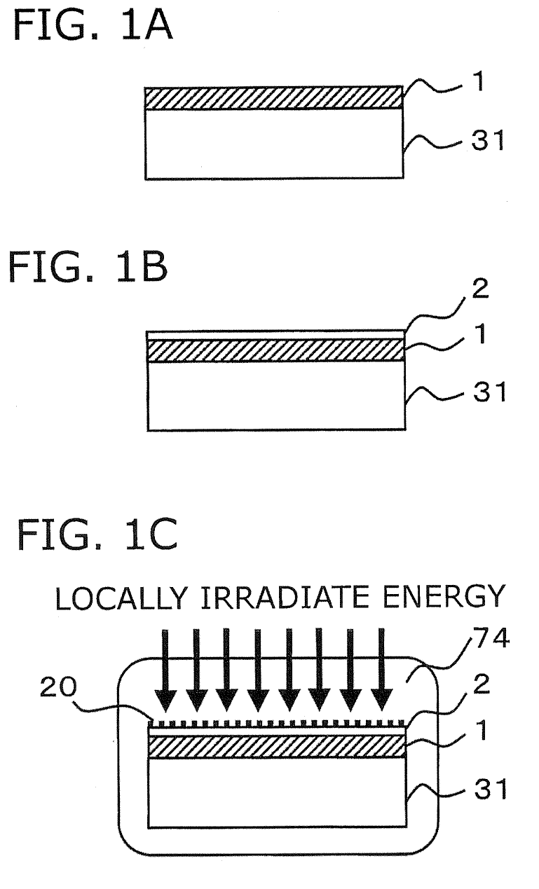

The insulating layer 2 (electron-emitting film; carbon film; semiconductor layer) having the dipole layer according to the embodiment of the present invention was manufactured according to the manufacturing method shown in FIGS. 1A to 1C.

In Example 1, pulsed laser light having a light absorbable wavelength is locally irradiated to the carbon film in a hydrocarbon atmosphere so that the terminating process is executed. That is to say, the carbon film absorbs coherent or non-coherent pulsed laser light, and thus its temperature rises. Since the carbon film is formed not on the entire surface of the substrate, the entire substrate is not heated to high temperature. For this reason, thermal damage on the substrate (change such as warpage or constriction due to heat history) can be reduced.

The manufacturing procedure is described in detail below.

Quartz was used as the substrate 31, and after the substrate 31 was sufficiently cleaned, TiN with thickness of 500 nm was formed as the cathode electrode 1 by the sputtering method (FIG. 1A).

The formation conditions are as follows:

Rf electric source: 13.56 MHz

Rf power: 7.7 W/cm²

Gas pressure: 0.6 Pa

Atmosphere gas: N₂/Ar (N₂: 10%)

Substrate temperature: room temperature

Target: Ti

The carbon film was formed into thickness of 4 nm on the cathode electrode 1 by the sputtering method, and the insulating layer 2 was formed (FIG. 1B). A graphite target was used as a target so that formation was carried out in an argon atmosphere. As a result, a substrate having the carbon film was prepared.

The surface of the insulating layer 2 was locally heated by using pulsed laser light in a mixed gas atmosphere of methane and hydrogen. As a result, the dipole layer 20 was formed on the surface (FIG. 1C). FIG. 1C shows an example where the dipole layer 20 is formed on the entire surface of the insulating layer 2, but a laser light is irradiated only to a target place so that the dipole layer can be formed only on this place.

The used pulsed laser light was an YAG laser, and a wavelength was 355 nm which was a third harmonic, a pulse oscillating frequency was 1 to 300 Hz, and laser energy density was 300 to 1000 mJ/cm² (preferably, 350 to 500 mJ/cm²).

Heat treatment (terminating process) conditions are described below:

Heat treatment temperature: 600° C.

Heating system: laser heating

Processing time: 60 min

Mixed gas ratio: methane/hydrogen=15/6

Heat treatment pressure: 6.65×10³ Pa

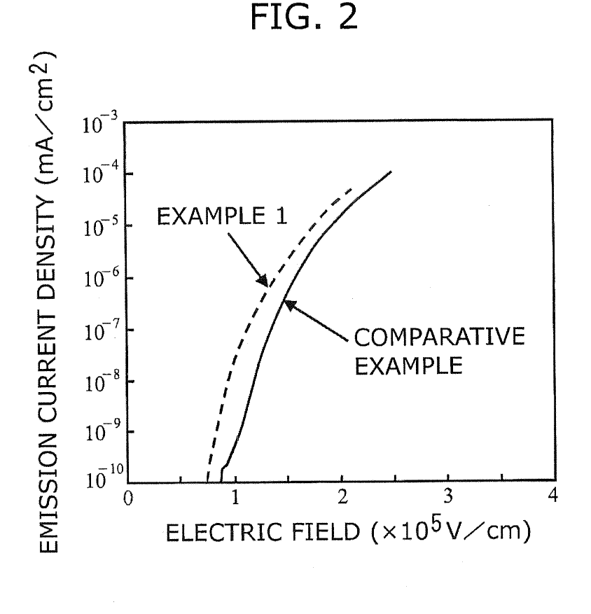

An electron emission characteristic (voltage-current characteristic) of the insulating layer manufactured in this example was measured. This measurement was taken by arranging an anode electrode (area was 1 mm²) on a position separated from and opposed to the insulating layer and applying a driving voltage between the anode electrode and the cathode electrode. The voltage-current characteristic at this time is shown in FIG. 2.

As shown in FIG. 2, the electron emission characteristic of the insulating layer manufactured in this example was compared with an electron emission characteristic of the insulating layer (comparative example) formed with the dipole layer by a conventional method (method described in Japanese Patent Application Laid-Open No. 2005-26209).

As is clear from FIG. 2, also the case of the dipole was formed by local heating using a laser (the insulating layer in this example), the electron emission characteristic which was equivalent to that of an insulating layer in a comparative example was obtained. Since only a local portion (insulating layer surface) is heated, the probability of occurrence of substrate deformation or the like can be reduced compared with a manufacturing method in the comparative example. For this reason, manufacturing efficiency can be improved further than the manufacturing method in the comparative example.

### Example 2

As an example 2, a case where instantaneous thermal annealing (RTA, local heating) is carried out using a lamp (typically halogen lamp) which can execute heat treatment only on a desired place is described. Since RTA can be carried out in a short time, improvement of productivity (production speed) is expected in the present invention.

A manufacturing procedure is described in detail below.

Similarly to the first embodiment, it was finished to the step in FIG. 1B. Thereafter, the insulating layer 2 was carried out the instantaneous thermal annealing (RTA) in a mixed gas atmosphere of methane and hydrogen.

This RTA treatment is carried out preferably at temperature of 600 to 800° C. and for short time of about 1 to 240 seconds using the RTA method. At this time, the carbon film is heated to about 600 to 650° C. due to a difference of a heat absorption factor in each materials, but the temperature of the substrate 31 becomes about 300 to 400° C. For this reason, damage on the substrate 31 can be repressed. Since the RTA treatment is carried out in a short time of about 1 to 240 seconds, the temperature of a thermally fragile glass substrate whose distortion point (flexibility point) is 600° C. or less does not rise much. For this reason, the distortion of the glass substrate due to heat can be repressed.

The electron emission characteristic of the insulating layer manufactured in Example 2 was measured. This measurement was taken by arranging an anode electrode (area was 1 mm²) on a position separated from and opposed to the insulating layer and applying a driving voltage between the anode electrode and the cathode electrode. As a result, also when the dipole layer is formed by the local heating using RTA (the insulating layer in Example 2), the electron emission characteristic, which is equivalent to a case (the insulating layer in the conventional example) of the conventional method (Japanese Patent Application Laid-Open No. 2005-26209), was obtained.

According to the manufacturing method of the electron-emitting device in the embodiment of the present invention, the hydrogen terminating process can be executed on a desired portion of the surface of the carbon film. Further, since only the surface of the insulating layer has high temperature, damage on the other layers can be reduced. Since the manufacturing method of the electron-emitting device according to the embodiment of the present invention can be executed in a short time, the productivity increases.

This embodiment describes the case where light of laser or RTA is irradiated locally, but even if a particle beam such as an electron beam, or an ion beam is irradiated, the effect equivalent to this embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-289651, filed on Nov. 7, 2007, which is hereby incorporated by reference herein in its entirety.

What is claimed is:

1. A manufacturing method of an electron-emitting device, comprising the steps of:
preparing a substrate having a carbon film; and
terminating a surface of the carbon film with hydrogen by irradiating a light or particle beam locally to a part of the carbon film in an atmosphere including hydrocarbon or hydrogen or in an atmosphere including both hydrocarbon and hydrogen.

2. A manufacturing method of an electron-emitting device according to claim 1, wherein a pressure of the atmosphere is not less than 2×10² Pa and not more than 7×10³ Pa.

3. A manufacturing method of an electron-emitting device according to claim 1, wherein the light is a laser light.

4. A manufacturing method of an electron-emitting device according to claim 3, wherein the light is pulsed laser light.

5. A manufacturing method of an electron-emitting device according to claim 1, wherein irradiating the light or particle beam locally to a part of the carbon film is instantaneous thermal annealing using a lamp.

6. A manufacturing method of an electron source having a plurality of electron-emitting devices, wherein each of the plurality of electron-emitting devices is manufactured by the manufacturing method of an electron-emitting device according to claim 1.

7. A manufacturing method of an image display apparatus having an electron source and a light emitting member for emitting light due to irradiation of electrons, wherein the electron source is manufactured by the manufacturing method of an electron source according to claim 6.
